(19) United States
(12) Patent Application Publication
(10) Pub. No.: US 2013/0185252 A1
(43) Pub. Date: Jul. 18, 2013

(54) Document Revision Manager

(71) Applicant: Jeffrey J. Palmucci, Brookline, MA (US)

(72) Inventor: Jeffrey J. Palmucci, Brookline, MA (US)

(21) Appl. No.: 13/743,599

(22) Filed: Jan. 17, 2013

Related U.S. Application Data
(60) Provisional application No. 61/632,036, filed on Jan. 17, 2012.

(51) Int. Cl. G06F 17/30

(52) U.S. Cl. CPC G06F 17/30011
USPC 707/608

(57) ABSTRACT

Methods, systems, tools and computer program products are provided that enable a document revision management system to utilize lockless collaboration such that a plurality of users can edit a plurality of document versions concurrently. The system uses a directed acyclic graph to store information concerning ancestry of versions of related documents and to track revisions between parent and children versions. The system provides users the ability to save versions as private or published and to apply security parameters so that only certain users or groups of users may see specific revisions and/or versions. The system can redact portions of the revision history for non-authorized users. Automated publication notifications can be distributed by the system to document moderators to update them of available changes to documents. The system allows for automated merging of non-conflicting changes as well as moderated merging when human interaction is desired and/or required.

### CROSS-REFERENCE TO RELATED APPLICATIONS

This application claims the benefit of U.S. Provisional Application No. 61/632,036 entitled DOCUMENT REVISION MANAGER and filed on Jan. 17, 2012, which is specifically incorporated by reference herein for all that it discloses and teaches.

### TECHNICAL FIELD

The present invention relates generally to the field of networked computers, and more particularly to a document revision management system and methods that can be utilized by a plurality of users to effectively collaborate upon and revise a plurality of documents.

### BACKGROUND

Since the early days of computing, users have wished to collaborate upon and concurrently revise documents. Prior to computers being networked together to transmit copies of documents, a single document was often transferred via a computer-readable storage medium—such as a floppy disk—manually between users. In this way, a first user could create a document and transfer it to a second user who could then make edits or otherwise revise the document. The second user could then transfer it to a third user for more revisions, etc. Such a single-document revision system was inefficient in that only one user could work on the document at a time; but it was relatively “clean” in that users' revisions would occur in serial so that no conflicting user revisions were generated.

Alternatively, a first user could give a copy of the document to a second user and also, concurrently, to a third user. The second user and third user could both make revisions to their individual documents and then transfer both revisions back to the first user who then had to manually attempt to merge the two revisions into a single document. Although this alternative method allowed document revision to occur in parallel, the multiple versions of the documents would have to be manually merged. The manual merger could be a difficult and time-consuming process, especially if the revisions conflicted. For example, if the second user and third user both modified the same section of the document, it could be difficult for the user performing the merger to decide on which competing revision to accept. This relatively simple problem grows exponentially worse when the number of people editing the document is increased beyond two or three.

As computing machines began to be networked and allow for easy transfer of information between them, the above processes could occur via email or through shared document repositories where multiple users could electronically access the various document revisions. However, although document transfer and access was greatly improved, the underlying problems of inefficient, serial revisions or conflicting parallel revisions remained.

Attempts to address these problems have generally followed one of two strategies: concurrent editing or document locking. In the former, multiple users access the same document concurrently and make changes in real time. Although such a system appears efficient on its face, it can introduce a number of other issues, such as: difficulties in moderating or approving changes, conflicts between users who wish to modify the same portion of the document but in divergent ways, and poorly detailed and demarcated or non-existent revision history tracking.

With document locking, a document is placed on a shared resource, such as a network storage device, and can then be ‘checked-out’ to an individual user who wishes to revise it. While it is checked-out, the document on the shared resource is locked so no other changes are made to it. Once the user makes his or her changes to the checked-out document, the revised document is uploaded back to the shared resource and ‘checked-in’. The document on the shared resource is then unlocked so that the next user can check-out the document for additional revisions. This system can have a much improved revision history, as it is clear which users have checked-out the document and what revisions each user has made. However, document locking reintroduces the inefficient model of allowing only a single user to revise a document at a given time. Further issues include whether a document moderator needs to approve each user's changes between checkouts, at predetermined intervals, etc.

Many existing document version control systems have another shortcoming: they attempt to address the needs of document version control through a completely linear structure of tracking changes. Such systems can be somewhat useful when only a single document is the subject of edits or changes; but when there are a group of related documents (e.g., a contract boilerplate document and resulting contracts), existing systems utterly fail to be of use. Also, for revisions to a single document, a linear change history cannot represent several concurrent edits to a document in that different edits may be based off of different versions. The problem of concurrent edits can become even worse on a moderated document since any edits cannot be applied until the moderator accepts them—potentially introducing long delays to the process.

Additional limitations of current systems include: a lack of tracking for published and private revisions, an inability for various revisions to be secured for viewing only by users of certain user groups, difficulties integrating revisions from other users while concurrently working on one's own revisions, an inability to collapse one's revisions into a smaller subset of revisions before releasing them to other users, etc.

What is needed is an improved document revision manager.

### BRIEF DESCRIPTION OF THE DRAWINGS

FIG. 1 illustrates an exemplary embodiment of operations for a method of managing a document revision system;

FIG. 2A illustrates an exemplary embodiment of user actions within a document revision system highlighting the system's “published” versus “private” functionality;

FIG. 2B illustrates an exemplary embodiment of a directed acyclic graph used to represent a state of an exemplary branching revision history;

FIG. 3 illustrates an exemplary embodiment of detailed user actions for employing a document revision system highlighting the notifications functionality of the system;

FIG. 4 illustrates an exemplary embodiment of detailed exemplary operations for a method of managing a document revision system;

FIG. 5 illustrates an exemplary embodiment of user actions for employing a document revision system;

FIG. 6 illustrates an exemplary embodiment of user actions for employing a document revision system;

FIG. 7 illustrates an exemplary embodiment of user actions for employing a document revision system;

FIG. 8 illustrates an exemplary embodiment of user actions for employing a document revision system;

FIG. 9 illustrates an exemplary embodiment of user actions for employing a document revision system;

FIG. 10 illustrates an exemplary embodiment of user actions for employing a document revision system in an inter-organizational collaboration where revision history security is employed;

FIG. 11 illustrates an exemplary embodiment of a directed acyclic graph used in the system;

FIG. 12 illustrates an exemplary embodiment of detailed exemplary operations for a method of managing a document revision system employing revision history security;

FIG. 13A illustrates an exemplary embodiment of user actions for employing a document revision system detailing a portion of the process of sidelining;

FIG. 13B illustrates an exemplary embodiment of user actions for employing a document revision system further detailing the process of sidelining;

FIG. 14A illustrates an exemplary embodiment of user actions for employing a document revision system further detailing the process of sidelining;

FIG. 14B illustrates an exemplary embodiment of user actions for employing a document revision system further detailing the process of sidelining;

FIG. 15 illustrates an exemplary embodiment of user actions for employing a document revision system detailing the process of pruning; and

FIG. 16 illustrates an exemplary embodiment of a computing system useful in implementations of the described technology.

### DETAILED DESCRIPTION

In the following discussion, numerous specific details are set forth to provide a thorough understanding of the present disclosure. However, those skilled in the art will appreciate that embodiments may be practiced without such specific details. Furthermore, lists and/or examples are often provided and should be interpreted as exemplary only and in no way limiting embodiments to only those examples.

Exemplary embodiments are described below in the accompanying Figures. The following detailed description provides a comprehensive review of the drawing Figures in order to provide a thorough understanding of, and an enabling description for, these embodiments. One having ordinary skill in the art will understand that in some cases well-known structures and functions have not been shown or described in detail to avoid unnecessarily obscuring the description of the embodiments.

It is to be understood by any skilled in the art that the methods described below can be implemented on a computing device employing software modules and one or more processors and that the terms method, process, step, and action can be used to describe events occurring in one or more software modules implemented on a computing device.

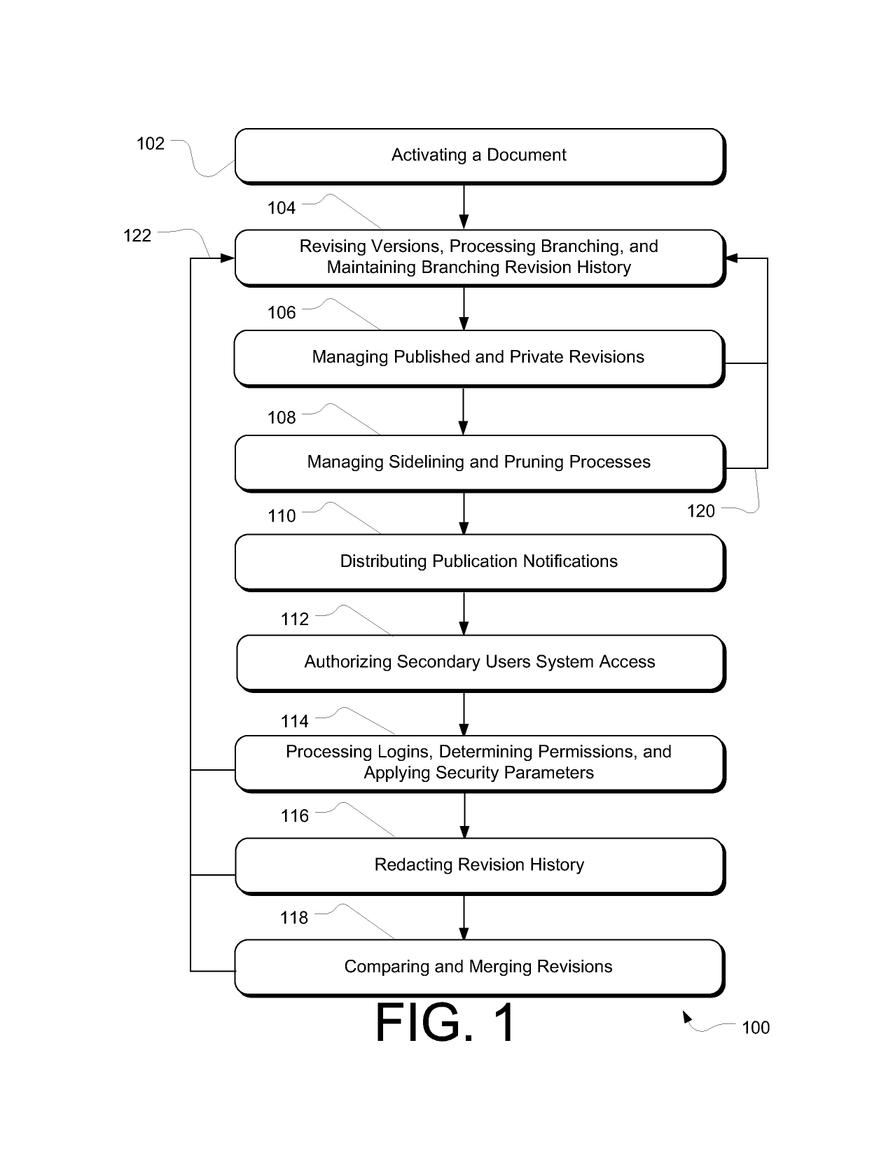

Referring now to the drawings, FIG. 1 illustrates an exemplary embodiment of operations for a method of managing a document revision system 100. The method is employed in a document revision management system in a computing device, the computing device operating software modules via one or more processors in order to allow a plurality of users to revise a formatted office document provided by a first user, the system utilizing lockless collaboration such that the plurality of users can edit a plurality of versions of the formatted office document concurrently; the software modules interacting to form a document revision management system. Formatted office documents include word-processing documents, webpages, slide presentations, etc. For example, such documents can be viewed as “What You See Is What You Get” (WYSIWYG) type documents. Formatted office documents do not include software code that must be interpreted to allow the content represented by the code to be displayed.

The exemplary operations shown in FIG. 1 comprise: Activating a Document 102; Revising Versions, Processing Branching, and Maintaining Branching Revision History 104; Managing Published and Private Revisions 106; Managing Sidelining and Pruning Processes 108; Distributing Publication Notifications 110; Authorizing Secondary Users System Access 112; Processing Logins, Determining Permissions, and Applying Security Parameters 114; Redacting Revision History 116; and, Comparing and Merging Revisions 118. Additional operations and sub-operations are contemplated in other embodiments.

The operation of Activating a Document 102 comprises providing a first user of the system with one or more options for selecting an original version of an active formatted office document. In one embodiment, the user is presented with the choices of making a new document in the system, importing a previously created document into the system, or selecting a currently existing system document. As another example, a formatted office document can also be brought into the system via clicking on a hyperlink from an email or some other location (such as on a social networking website), inputting a URL address into a web browser, uploading a document, etc. Once selected, the document becomes the active document.

The operation of Revising Versions, Processing Branching, and Maintaining Branching Revision History 104 may comprise multiple sub-operations. In the Revising Versions sub-operation, the system presents one or more versions of the active document to a plurality of users and allows the user to select one for editing. In one embodiment, a second user selects the most recent version. Editing can include the second user (or any of the plurality of users) revising the selected version, modifying document properties, sharing the document, downloading the document, deleting the document, etc. Revising includes making one or more revisions to the version in order to create a first version which differs from the original version by a first set of revisions. Copying a formatted office document causes the splitting off of a related formatted office document that shares the branching revision history of the original document. The original and the copy each have a corresponding current version in the branching revision history. In one embodiment, document properties include selecting moderated or unmoderated access (see Distributing Publication Notifications 110 for a discussion of this) and/or setting security parameters. In another embodiment, the user can set the permissions to allow: (i) anyone with a link to the document can view, copy and/or examine the revision history of the document (or a portion thereof); or (ii) only members who are authorized through the system's access control rules are able to view, copy and/or examine the document's revision history (or a portion thereof). Various effects of these permissions settings and related information are discussed below, see security parameters. Sharing the document can involve making the document available to others via email, as a link, as an attachment, through a social networking website, via an automatic group association, etc. Downloading the document comprises saving a copy of the document in a location other than in the system. Deleting the document removes the document from the user's list of available documents.

The sub-operation of Processing Branching involves the system managing the various users accessing the documents and copies thereof, as well as how the users interact with the documents and how those documents interrelate to one another. The sub-operation of Maintaining Branching Revision History comprises initiating a branching revision history by processing a directed acyclic revision history graph that stores information concerning ancestry of the plurality of versions of the formatted office document; and then updating and maintaining that branching revision history by tracking user revisions of versions (including any and all changes to a version, its properties, metadata, etc.) as well as any ancestry versions and revisions thereto and updating the graph. For example, the system can track the first set of revisions in the branching revision history based on user actions concerning the first set of revisions. The revision history includes information about the first user, the second user, the original version, the first version, interrelations between the original version and the first version, and information regarding the first set of revisions.

At various logical times, users will save changes to a version resulting in a new version being created in the revision history. In one embodiment, the branching revision history consists of a directed acyclic graph where nodes represent various document versions and edges represent version ancestry. The parent (source of the directed edge) of any later version in the revision history is the version or versions from which the later version was created. This revision history may be shared between multiple documents or copies of the same document being edited by different users. For example, if a user copies a document, the content of the copy is initially identical to the original, and the most current version for both documents refers to the same version in the shared revision history. When a user's version of a document diverges from other users' versions, or a copy of a document diverges from the original, it is represented by a branch in the revision history (two or more versions having the same parent), with each branch representing the changed content in the respective documents. If changes from one or more divergent versions are merged together to result in a new version with all the changes of each, this is represented as a merge in the branching revision history (one version having two or more parents). Related documents are defined to be those that share a common version in their ancestry.

The operation of Managing Published and Private Revisions 106 comprises the system presenting users with the option of saving a new version of a document in a published or private form. In another embodiment, this process can also include the ability for a user to un-publish a document version. When a user chooses to either save a version as published or otherwise publishes a version, the user is specifying that his or her revisions are ready to be viewed by others. If a user is not ready to release his or her revisions to others, the user can choose to save the version as private and then the only person that can see that revision of the document is the user. Note that if the user later publishes the version, then the revisions embodied in the earlier private version(s), if any, also become published (see pruning for additional related information).

For example, if the user wishes to save his first set of revisions so that others cannot view the revisions, the system provides a means for saving a first version which differs from the original version by that first set of revisions. The system saves the first version as private so only the user can view the revisions. Alternatively, if the user wishes to save his first set of revisions so that others can view the revisions, the system provides a means for saving a first version which differs from the original version by that first set of revisions. The system saves the first version as published so that others can view the first set of revisions.

The operation of Managing Sidelining and Pruning Processes 108 may comprise two sub-operations: Managing Sidelining Processes and Managing Pruning Processes. Managing Sidelining Processes involves the system offering a user the option to sideline any private revisions. When activated, versions including such private revisions are “side-lined” from the revision history, thereby allowing the user to merge in other users' revisions, or new revisions of his or her own, into the current version without incorporating those changes from the sidelined revisions. Once the other revisions have been merged in, the user can unsideline the previously sidelined version(s). Unsidelining involves merging the sidelined version(s) into the (possibly changed) most recent version as pending private revisions. In one embodiment, the system provides the first user a means for revising the original version of the document to create a sideline version of the plurality of versions, wherein the sideline version differs from the original version by a sideline set of revisions. The system then maintains the sideline version apart from the other versions, and then comparing and merging operations between the other versions can occur. Once a new third version has been created by merging two or more other versions, the system can then provide the first user a means for comparing and merging the sideline version with the third version; wherein the system provides the first user a means for reviewing the sideline set of revisions and selectively merging at least one revision of the sideline set of revisions with the third version to create a fourth version.

Managing Pruning Processes involves the system offering a user the option to prune two or more private versions together into a single, final set of versions before being published. This allows a user to clean up his or her revision history somewhat and effectively hide versions that he or she does not want to be a part of the published history. In another embodiment, a user is able to prune private and/or published versions in order to hide revisions and/or streamline the revision history across both types of versions.

The operation of Distributing Publication Notifications 110 comprises the system examining the document revision history and branches to determine which users need to be notified when a version is published. For documents that share the same revision history, the system provides the first user a means for selecting whether notifications between the related documents are one of unidirectional, bidirectional, and non-existent. The user thus has the ability to specify that notifications be sent from one document to the other when the first has a new published version that is not yet in the ancestry of the second. In one embodiment, the notification includes options to compare and merge the new revisions from the source document to the destination document. Notifications can be bidirectional or unidirectional (or non-existent, if not needed), as required by the relationship between the documents. For example, for users that are collaborating on a document, bi-directional notification can be set up between the moderator's view of the document, and the views of the document being edited by other users. That way, the moderator will be notified when a user is submitting a new change, and all users will be notified when the moderator accepts another change into the document. In another example, uni-directional notification can be set up from a document containing contract boilerplate to the individual contracts copied from that boilerplate. That way, changes made to the boilerplate are displayed on the contracts for possible inclusion or comparison, but the deal-specific changes made on the contracts do not show up on the boilerplate. In another embodiment, the system automatically sets bidirectional notification between two users' views of the same document, and the system allows optional uni- or bi-directional notification when a user makes a copy of a document. In yet another embodiment, notifications are stifled if users are not authorized by the permissions and security parameters to view both the source and the target documents.

In one embodiment, a user can stifle notification along a particular link in order to prevent spammy, malicious, or otherwise unwanted edits from showing up. In yet another embodiment, a user can set a document to automatically accept changes upon notification if no merge is required. That is, if the version on the notification link is already a descendent of the document's most recent version (or optionally can be merged without conflict), the change on the link is automatically made the most recent version in the target document. This way, the system can provide unmoderated access to a document because a merge by any user (not just a designated moderator) to a linked document's most recent version will cause that document to be updated. For moderated and shared documents, the moderator's view of the document has non-automatic links from other views of the documents, so that the moderator has a chance to review changes before they are integrated into the document. Automatic notification links go from the moderator's view to the other views because once a change is accepted by the moderator, it should be integrated into other views as soon as possible. For unmoderated documents, automatic notification links go in both directions (to a system created moderator view) so that anyone may integrate a change and have it immediately available to others sharing the document.

In yet another embodiment, notifications are made available to users when they are logged into the system; additionally, notification messages can be made through email, voicemail, phone calls, website postings, or any other external communication system. Notifications in the system can consist of bidirectional links between document views, including views on related documents. These links can have “auto merge” set, which means that if a change appears on the “from” branch, the change is automatically merged to the “to” branch. In one example, if a document is moderated, a notification link occurs from the moderator's view to the other contributor's views with auto merge enabled. Thus, when the moderator accepts and publishes a change, that change is automatically applied to the other contributor's views. There may also be links from the other contributor's views to the moderator's, but these have auto merge disabled because the moderator must explicitly apply a change for it to appear in a document. (i.e., the moderator must approve any changes.) On the other hand, if a document is unmoderated, auto merge is simply enabled in both directions. A change published by any user will automatically be applied to the moderator view, and immediately be applied again to the other contributors (assuming there are no conflicts that may be dealt with manually). In yet another embodiment, two views of a document can both be moderated such that auto merge is not enabled in either direction, which commonly occurs between related documents.

It is contemplated that an embodiment using varying moderation status based on particular users (or group memberships thereof) could be used. In this embodiment, a document could be moderated by user A in regards to users B, C, and D (who are members of the group “associates”) and unmoderated by user A in regards to users E, F, and G (who are members of the group “partners”). In this way, some users' revisions could auto merge into the document while other users' revisions have to be reviewed by a moderator before being merged into the document.

The operation of Authorizing Secondary Users System Access 112 comprises the system processing secondary users (i.e., any user besides the first user discussed above) and allowing authorized secondary users system access. Users can be authorized based on organization membership, sub-group membership, individual authorization, etc.

The operation of Processing Logins, Determining Permissions, and Applying Security Parameters 114 may comprise three sub-operations. The sub-operation of processing logins involves accepting user login information, determining if the user is authorized to access the system, and logging the user in to the system. The sub-operations of Determining Permissions and Applying Security Parameters examines a user's documents/versions and associated ancestry trees and references the permissions and security parameters to apply notifications accordingly upon user login. Specifically, the user's individual identity or membership in organizations and groups within organizations may be considered and individual document properties can then be interpreted to allow or deny the user access to one or more portions of a given document's revision history. See other sections for more detail on permissions, security parameters, organizations and groups. Applying security parameters can also include the system providing the first user a means for specifying security parameters for a document; wherein the parameters determine which users can access which versions of the document. Furthermore, applying security parameters can include the system displaying the branching revision history such that details concerning a specific version in the branching revision history are hidden from unauthorized users.

The operation of Redacting Revision History 116 comprises the system hiding certain versions in the revision history from unauthorized users. Since the system supports a shared revision history for multiple related versions, and each version may have access control such that only a subset of the users of the system may view the version, the system may extend access control to the revision history. Versions in the revision history that the current user is not authorized to view may be redacted. If a version or set of contiguous versions are redacted, only the final version of the set will be visible to the unauthorized user. Also, any metadata (e.g. version author, version description, version creation time, etc.) associated with the redacted versions may also be hidden. In one embodiment, versions in the revision history initially share the access control rules with the document on which the version was created. So, if a user does not have access to a certain document, and a version in the revision history was created on that document, that version will be hidden from that user. In certain incarnations of the system, revision history editing operations may change this relationship at a later time. In another embodiment, an operation of Redacting Revision History 116 can be applied to other types of data objects besides formatted office documents.

The operation of Comparing and Merging Revisions 118 may include the sub-operations of Comparing Revisions and Merging Revisions. Comparing Revisions can include: the system providing users with the ability to compare any two versions (assuming they are authorized to work with each version) in a document's revision graph to each other, including those from other users or related documents with available updates that the user has yet to merge; and the system can automatically compare the versions and determine if there are any conflicts of if an automated merge can occur.

In one embodiment, a directed acyclic graph representing the revision history is displayed. The user can choose which version will be the initial or “before” version and which will be the “after” version. The system then generates a sequence of document changes that transforms the before version into the after version, highlights those changes, and displays the results for the user's review. Thus, the requesting user can see differences between selected versions of the document in the branching revisions history, as well as corresponding metadata.

Merging Revisions involves the system merging at least one revision with the user's most recent non-sidelined version. In one embodiment, if the most recent non-sidelined version is an ancestor of the version to merge, the version to merge is accepted to be the new most recent version. Otherwise, the system attempts to find a version that is the direct child of both versions to merge and accepts that as the new most recent version (as is the case when another user has already merged the given versions). If neither of the above scenarios apply, the system traces through the revision history to find the most recent common ancestor and performs a three-way merge operation to create a new most recent version. A document can be configured to automatically accept document changes when there are no conflicts or when a merge has already been done by another user, thereby allowing the system to automatically update a document without requiring the user to moderate the process. In another embodiment, if a document is the target of an automatic notification link and the target document is an ancestor of the source document, or optionally when a non-conflicting merge can be done, the system may automatically update a document without requiring a user to intervene in the process. Alternatively, the user can specify which document changes he or she wants to accept or reject, allowing the user to moderate changes to the document. Further, when a revision is available that includes conflicting changes (such as one person editing a sentence and another deleting the entire sentence), the system highlights the conflicting changes and provides them to the user performing the merge for consideration and decision on which, if any, of the conflicting changes to accept. In other embodiments, other means of Merging Revisions are contemplated.

In another embodiment, the system can provide the first user with a means to choose whether the comparing and merging revisions operation is moderated such that the first user determines which of the first set of revisions is merged into a third version during the comparing and merging revisions operation. If the first user chooses to moderate, the system will provide notification to the first user when the second user makes the first version available. The first version differs from the original version by a first set of revisions and the first user can choose to accept or deny each revision. The system can also provide notification to the second user when a merger occurs that results in a third version.

In yet another embodiment, if the user chooses for the comparing and merging revisions operation to be unmoderated, the system then automatically merges at least some of the first set of revisions into a third version once the first set of revisions become available.

The system is not limited to performing the above operations in any specific order or number of repetitions, unless required above. Instead, many of the operations will occur in differing orders relative to one another depending on the actions of the users. Furthermore, operations can occur concurrently and can be repeated many times as a document is revised by a plurality of users. For example, the first arrow 120 highlights the fact that many times the operation of Revising Versions, Processing Branching, and Maintaining Branching Revision History 104 will be repeated following the operations of Managing Published and Private Revisions 106 or Managing Sidelining and Pruning Processes 108. Similarly, the second arrow 122 highlights the fact that many times the operation of Revising Versions, Processing Branching, and Maintaining Branching Revision History 104 will be repeated following the operations of Processing Logins, Determining Permissions, and Applying Security Parameters 114; Redacting Revision History 116; and Comparing and Merging Revisions 118. It should be noted that although the above system functionality is designed to work specifically with formatted office documents, other types of documents, files, computer readable data, etc. can be processed in other embodiments.

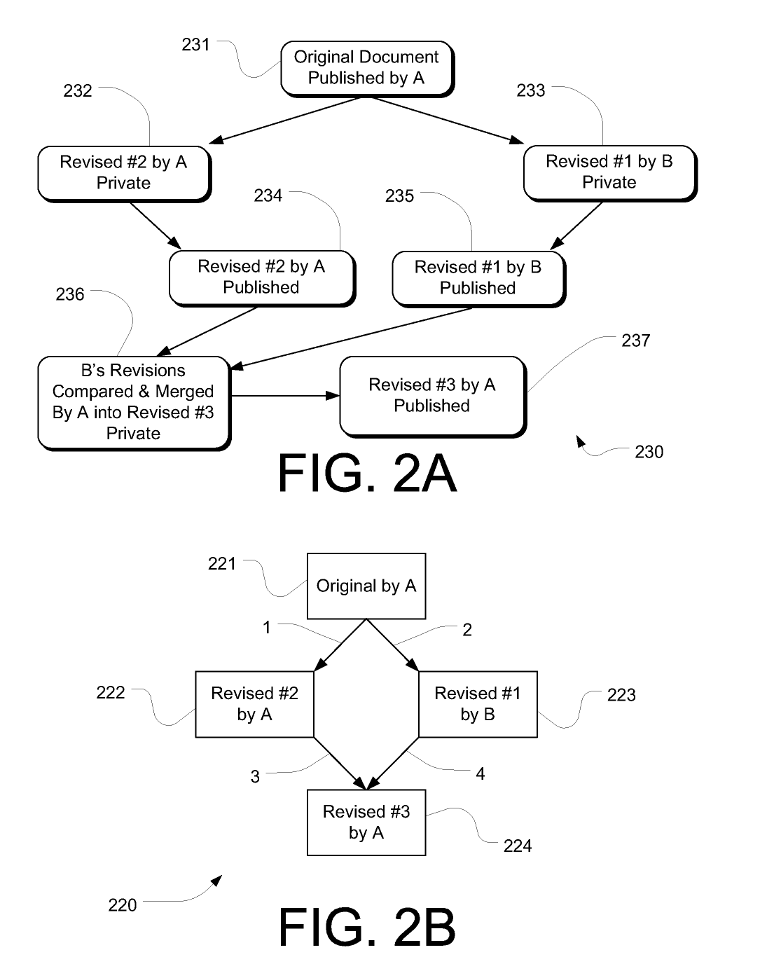

FIG. 2A illustrates an exemplary embodiment of user actions within a document revision system 230 highlighting the system's “published” versus “private” functionality. In the action “Original Document Published by A” 231, the user is “A”, and the system authorizes him to publish a version of an original document. Following this action, user A takes advantage of the system's revising versions functionality (see FIG. 1) to make revisions to the document, which creates a new version labeled Revised #2 in the action “Revised #2 by A Private” 232. In action 231, A had not yet chosen to publish his changes (i.e., make them available/viewable to other users in the system). Similarly, user “B” concurrently makes his own revisions to the document, which are labeled Revised #1 in the action “Revised #1 by B Private” 233. In both cases, the system provides users with the option to save their initial versions as private (or published), and the system carries out the chosen task. As the system does not share private versions, these revisions remain private following actions 232 and 233. However, in the action “Revised #2 by A Published” 234, user A chooses to publish Revised #2. The system then makes those revisions available to B (who is on the notification list for the original document). Similarly, in the action “Revised #1 by B Published” 235, user B chooses to publish Revised #1. The system then makes those revisions available to A (who is on the notification list for the original document).

In the action “B's Revisions Compared and Merged by A into Revised #3 Private” 236, user A acts on the notification he received from the system following B's publication of B's revisions in action 235. User A compares the changes made by B and merges them into Revised #2 to form a new version called Revised #3. User A chooses to save the combined file as private in action 236. However, in the action “Revised #3 by A Published” 237, user A then publishes Revised #3. This set of user actions illustrates an exemplary embodiment of the published and private functionality of the system using a simple two-user model.

FIG. 2B illustrates an exemplary embodiment of a directed acyclic graph used to represent the state of the branching revision history 220 at a point in time just after action 236 in FIG. 2A. The branching revision history 220 consists of a directed acyclic graph in which the nodes of the graph 221, 222, 223 and 224 represent versions of a formatted office document that various users have saved from time to time. In addition to the content of the document version, the nodes may contain metadata such as author, creation date, security information, etc. The edges 1, 2, 3 and 4 (represented by arrows in FIG. 2B) between the nodes represent the ancestry of a version. An edge points from a parent version to a later child version and indicates that the child version was created from the parent version. A branch point consisting of two or more children having the same parent indicates versions diverging from each other. For example, the two edge arrows 1 and 2 represent a branch point flowing from “Original by A” node 221. The branch point indicates that both “Revised #2 by A” node 222 and “Revised #1 by B” node 223 are revised versions (or children) of the “Original by A” node 221. A merge point consisting of two or more parents having the same child indicates that the child has incorporated all the revisions represented by the parents. For example, the two edge arrows 3 and 4 represent a merge point and indicate that “Revised #3 by A” node 224 includes both the set of revisions introduced in “Revised #2 by A” node 222 and the set introduced in “Revised #1 by B” node 223.

The current state of a set of related documents is represented by pointers into the branching revision history graph. FIG. 2B shows the state of the system after action 236 from FIG. 2A. A's published version “Revised #2 by A” node 222 (created in FIG. 2A, action 234) and A's private version “Revised #3 by A” node 224 (created in FIG. 2A, action 236) are different from each other, with the private version being a descendent of the public version (and also a descendent of B's published version “Revised #1 by B” node 223). As shown in FIG. 2B, the state of the system immediately following action 236 from FIG. 2A has user B without a private version. B's previous private version created in “Revised #1 by B Private” action 233 became B's public version “Revised #1 by B” node 223 when B undertook “Revised #1 by B Published” action 235. Moving forward following action 236, if A were to copy his public version “Revised #2 by A” node 222 to create a new related document, that document's current state would be represented by a pointer to the version “Revised #2 by A” node 222. Once revisions were made to that new related document, a new branch would be formed branching from “Revised #2 by A” node 222.

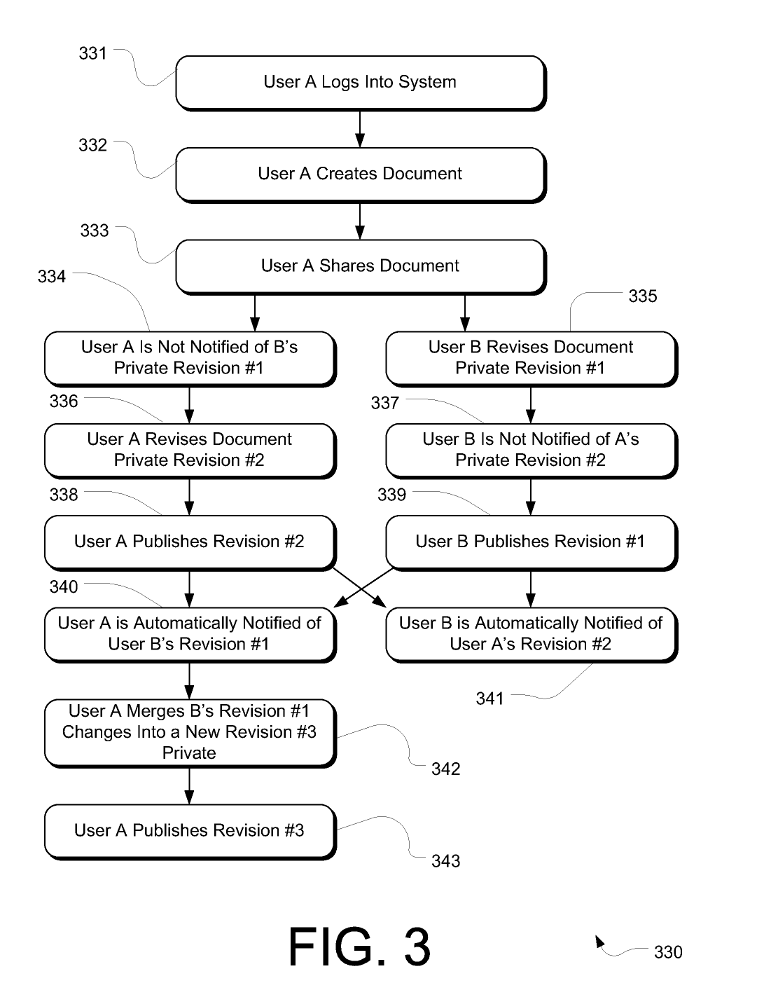

FIG. 3 illustrates an exemplary embodiment of detailed user actions for employing a document revision system 330 highlighting the notifications functionality of the system. In the “User A Logs Into System” action 331, the system presents user “A” with the ability to log into the system, and once he does so, user A is authorized to begin interacting with documents managed via the system (to which his security permissions give him access). In the “User A Creates Document” action 332, user A creates a new document (or otherwise causes the system to recognize a new document). Whenever a new document is created or otherwise first recognized by the system, such a document can be automatically published by the system. Following this action, A sends the URL link for the document to user B, in the “User A Shares Document” action 333. As noted above, the system can provide A with many different means for sharing a document with other users including emailing, texting, posting URL, etc.

When user B enters the system and edits A's document, the system sets up a view of the document owned by user B with bidirectional notifications to user A's document. User B makes revisions to his version of the document, which are labeled Revision #1 in the “User B Revises Document Private Revision #1” action 335. In action 334, “User A Is Not Notified of B's Private Revision #1”, A is not notified by the system of B's revisions (Revision #1) because B chose to save her document version as private instead of published. Similarly, in action 336, “User A Revises Document Private Revision #2”, A chooses to save his revisions as private; and so in action 337 “User B Is Not Notified of A's Private Revision #2”, user B is not notified by the system of A's revisions (Revision #2) because A chose to save his revisions as private.

In actions 338 “User A Publishes Revision #2” and 339 “User B Publishes Revision #1” both users decide to publish their revisions. Because of the bidirectional notifications set up above, the system then takes actions 340 “User A Is Automatically Notified of User B's Revision #1” and 341 “User B is Automatically Notified of User A's Revision #2”. In action 340, upon the publishing by B of her revisions, the system automatically notifies other users who have documents that share a revision history and notification links with B's document. Since A's view has such a notification link, A automatically receives notification of B's revisions. Similarly, in action 341, upon the publishing by A of his revisions, the system automatically notifies other users who have documents that share a revision history and notification links with A's document. Since B's view has such a link, the system automatically notifies B of A's revisions published as Revision #2.

In action 342 “User A Merges B's Revision #1 Changes Into a New Revision #3 Private” user A, after examining the revisions made by B in Revision #1, accepts the revisions and merges them into his Revision #2 version. User A chooses to make the new version private initially (so no notification is initially sent to B). Then, in action 343 “User A Publishes Revision #3”, A decides to publish his Revision #3. Because A's version has a notification link to B's version, B is notified of Revision #3 that consists of B's Revision #1 merged with A's Revision #2. In another embodiment, the system annotates B's version's revision history to reflect the current status of the changes with respect to A's version. For example, if A is the moderator, changes to B's version of the document that have not yet been merged by A are marked “pending review”. B's changes may appear in A's inbox. Once A does the merge with B's version, the version will be removed from the inbox and the “pending review” flag will be removed.

In yet another embodiment, if there is no moderator and A publishes his version first, it will become the new version of the document. B's subsequently published version, since it does not include A's changes to the current document, will be marked as “requires merge”. When B merges his version with A's version of the document and publishes the merged version, the merged version becomes the current version of the document and the “requires merge” flag is removed. In this way, B can see which versions have not yet been accepted into A's version history.

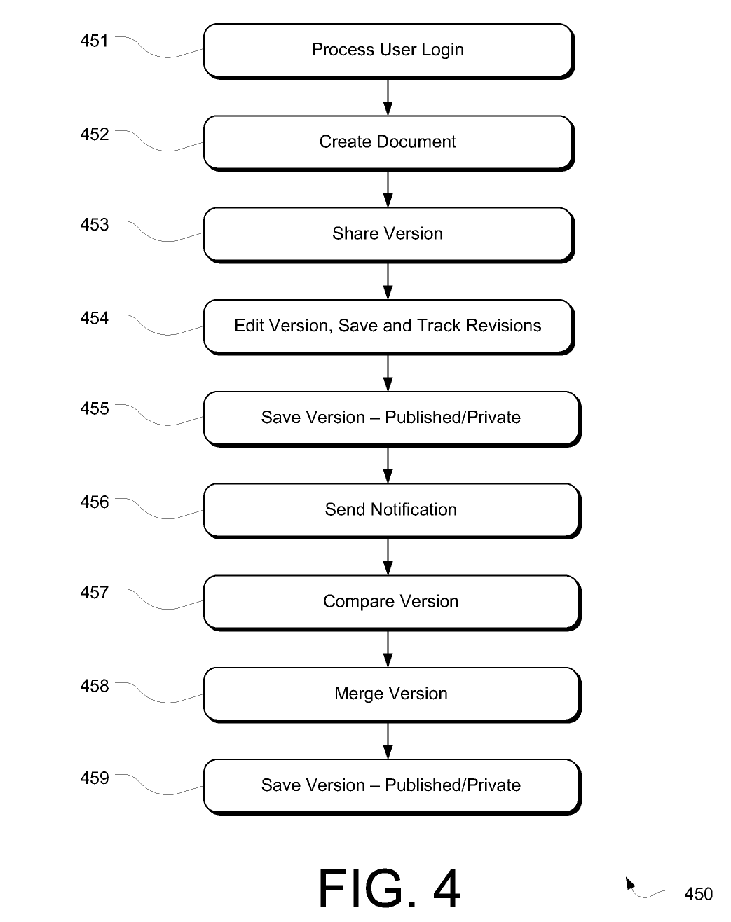

FIG. 4 illustrates an exemplary embodiment of a method of managing a document revision system 450. In the illustration in FIG. 4, a basic method is shown; more complex methods are contemplated in other embodiments. In the “Process User Login” step 451, the system presents a log in option to the user and processes input information in order to ensure the user is authorized to access the system. In this step, the system also looks up user profile, preferences, documents, etc., creates the appropriate user “space” and then presents it to the user upon log in. In the “Create Document” step 452, the user has requested that the system create a new document and the system does so either by presenting a new blank document or allowing the importation of a document. The “Share Document” step 453 occurs when the user activates the Share menu option. The system can present the user with a number of different sharing options (such as via email, as a website link, as an attachment, via social networking tools, etc.) and then can assist the user in accomplishing the sharing.

In the “Edit Version, Save and Track Revisions” step 454 the system provides a plurality of users with the ability to edit the document (i.e., create revisions or new versions). The system saves and tracks the revisions as a version in the revision history (called the working version) starting with the original new document created in step 452 “Create Document”. Users are provided with the opportunity to save the working version in the “Save Version—Published/Private” step 455. Here the system presents the users with the ability to save a particular set of revisions as a private version (i.e., no other users will be notified of the changes nor allowed to view them) or as published (i.e., other users can be notified of the changes and allowed to view them). If a user chooses to save his or her document revisions as published (i.e., publish the changes) then the system, in step 456 “Send Notification”, will automatically notify all those users who have documents that have notification links from the first document of the new published version and the changes embodied therein.

Any user who receives the notification can then choose to act upon it. In step 457 “Compare Version”, the system presents a user with the option to compare the new published version with that user's current version (or with previous versions in the revision history). The user can choose to have the system perform the comparison, and will then be presented with the option of automatically merging the changes into his or her document if there aren't any conflicts, or being presented with the differences and given an opportunity to accept or reject them on a case by case basis. This step is the “Merge Version” step 458 in which the system either automatically performs the merge at the user's bidding, or interacts with the user to manually perform the merge. In the “Save Version—Published/Private” step 459, the system allows the user to save his or her newly merged document as either private or published.

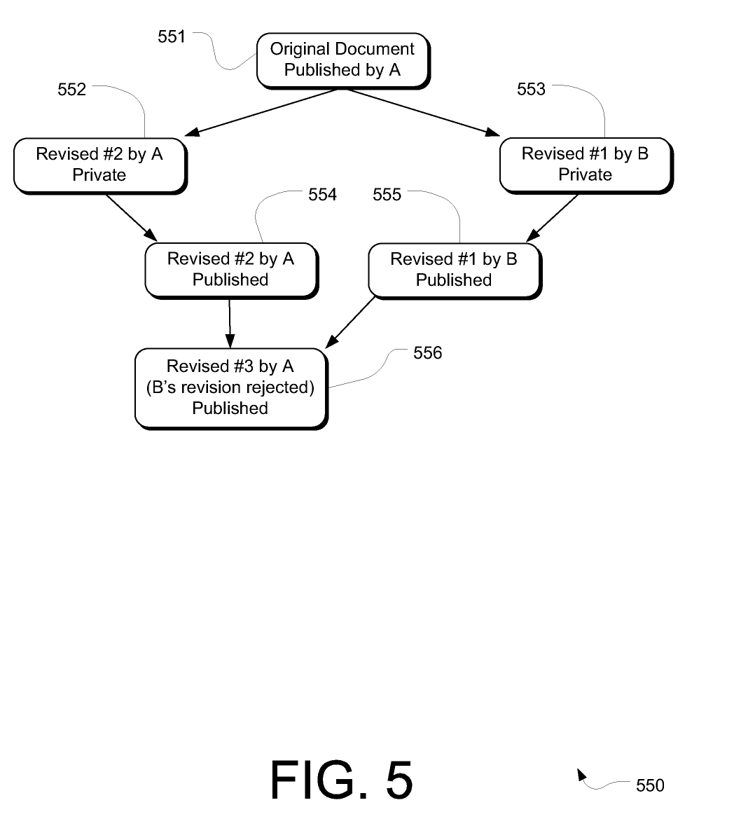

FIG. 5 illustrates an exemplary embodiment of user actions for employing a document revision system highlighting the rejection of revisions presented by one user to another 550. In this illustration, user A publishes an original version of a document in action 551 “Original Document Published by A”. The system empowers user A to share this published document with user B who then creates a revision and saves it as “Revised #1” in the “Revised #1 by B Private” action 553. The system automatically sets up a bidirectional notification link between A's view and B's view. As B initially saves Revised #1 as private, the system does not notify A of the revision or make Revised #1 available to others until after action 555 when B publishes Revised #1. In action 552 “Revised #2 by A Private”, A also makes a revision and saves it as private so B is not aware of the revision until after action 554 “Revised #2 by A Published”, when the system notifies B of A's new version. Subsequent to being notified of B's Revised #1, A reviews the changes and decides to reject B's revisions while making additional revisions of his own in action 556 “Revised #3 by A (B's revision rejected) Published.” Since A also published Revised #3, B would be notified of A's newest version.

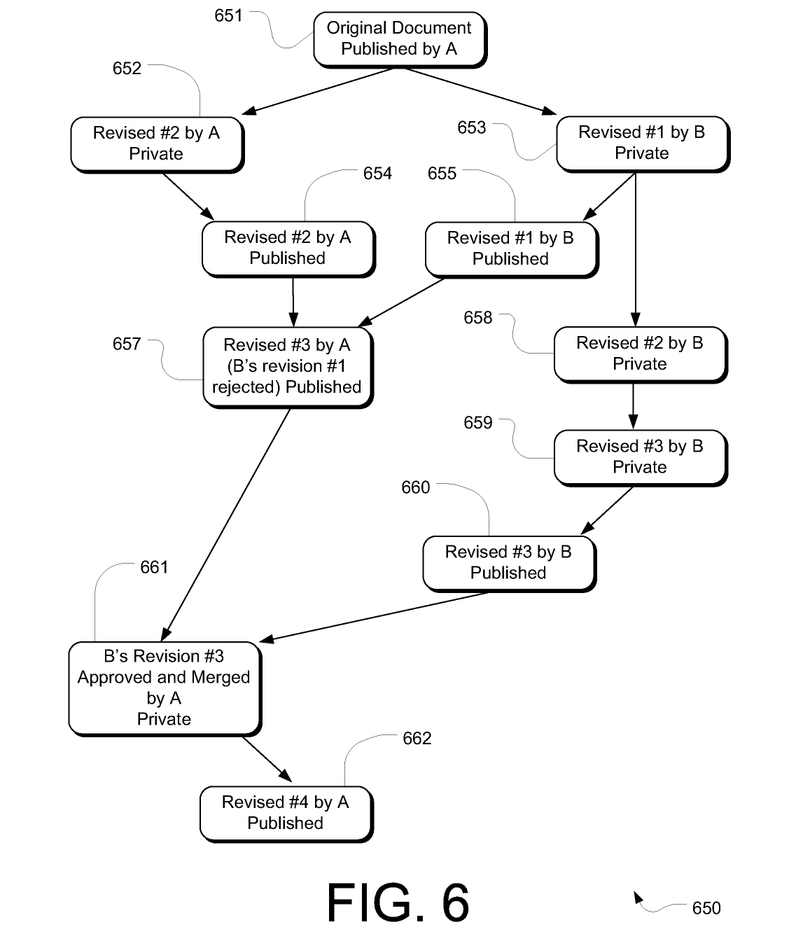

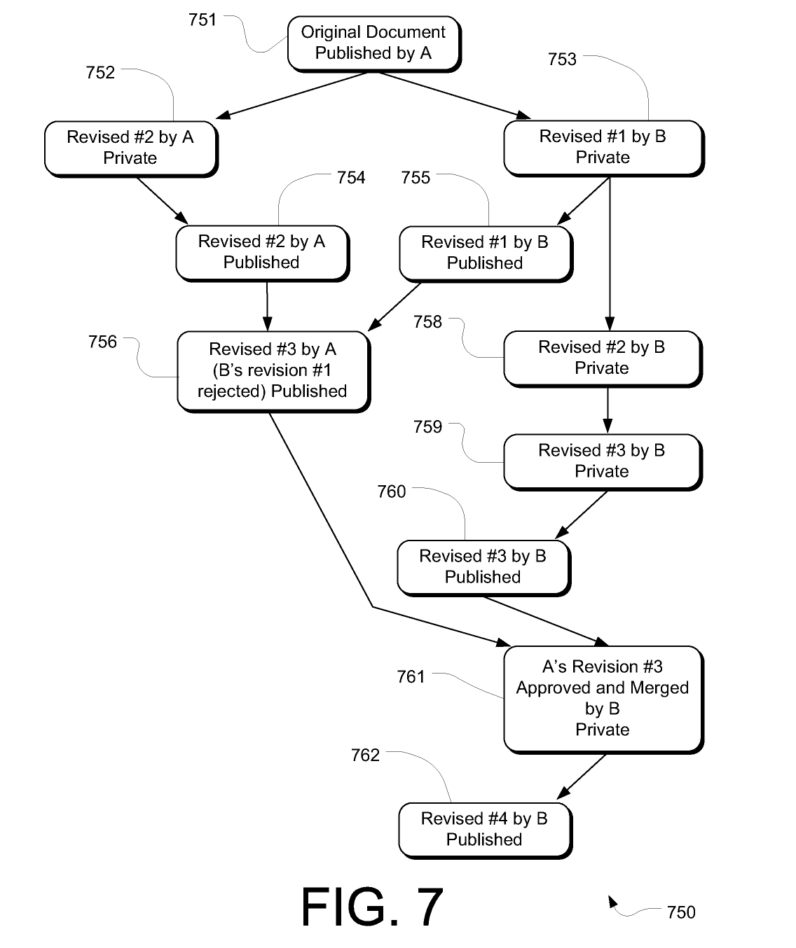

FIG. 6 illustrates an exemplary embodiment of user actions for employing a document revision system 650. Although FIG. 6 may represent a number of different scenarios, it may be viewed as user A acting as the moderator of a document on which user B is collaborating. Similarly, the exemplary embodiment illustrated in FIG. 7 may be viewed as B creating a copy of A's document and B then moderating his own document.

In this illustration, user A publishes an original version of a document in action 651 “Original Document Published by A”. User A shares this published version with user B who then creates a revision and saves it as “Revised #1” in the “Revised #1 by B Private” action 653. As B saves Revised #1 as private, the system does not notify A of the revision or make Revision #1 available to others until after action 655 “Revised #1 by B Published”, wherein B publishes Revised #1. In action 652 “Revised #2 by A Private”, A also makes a revision and saves it as private so B is not aware of the revision until after action 654 “Revised #2 by A Published”, when the system notifies B of A's revision. In another embodiment, if automatic notification links had been established from A's version to B's, then when A published his Revised #2, the system could automatically integrate A's revisions embodied in Revised #2 by A into B's working version.

In the embodiment shown in FIG. 6, subsequent to being notified of B's Revised #1, A reviews the changes and decides to reject B's revisions while making additional revisions of his own in action 657 “Revised #3 by A (B's revision #1 rejected) Published.” Since A also published Revised #3, B would be notified of A's newest revision and the fact that A rejected B's initial revisions could also be communicated. Meanwhile, in actions 658 “Revised #2 by B Private” and 659 “Revised #3 by B Private”, B makes two additional revisions of his own and saves them as private. Although B is notified of A's Revised #2 and A's Revised #3, B takes no action to merge or reject A's revisions into B's own working version. In action 660 “Revised #3 by B Published”, B publishes his Revised #3 whereby the system then notifies A of B's Revised #3, and action 661 “B's Revision #3 Approved and Merged by A Private” occurs. In action 661, A reviews B's newest revisions, approves of them and merges them into A's Revised #3 as private. Then in “Revised #4 by A Published” action 662, A publishes the combined Revised #4 document. Although not shown in FIG. 6, B is notified of A's Revised #4 being published.

FIG. 7 illustrates an exemplary embodiment of user actions for employing a document revision system 750 highlighting some of the flexibility of the system in allowing other users besides the originator of the original document to approve, merge, and publish revisions. Although FIG. 7 may represent a number of different scenarios, it may be viewed as A acting as the moderator of a document, B creating a copy of A's document and B then moderating her own version. In this illustration, user A publishes an original document in action 751 “Original Document Published by A”. User A shares this published document with user B who then creates a copy and saves it as “Revised #1” in the “Revised #1 by B Private” action 753. The system can then respond to this action by automatically setting up bidirectional notification between the two related documents. As B initially saves Revised #1 as private, the system does not notify A of the revision or make Revised #1 available to others until after action 755 “Revised #1 by B Published”, wherein B publishes Revised #1.

In action 752 “Revised #2 by A Private”, A also makes a revision and saves it as private so B is not aware of the revision until after action 754 “Revised #2 by A Published”, when the system notifies B of A's revision. Subsequent to being notified of B's Revised #1, A reviews the changes and decides to reject B's revisions while making additional revisions of his own in action 756 “Revised #3 by A (B's revision #1 rejected) Published.” Since A also published Revised #3, B would be notified of A's newest revision. Meanwhile, in actions 758 “Revised #2 by B Private” and 759 “Revised #3 by B Private” B makes two additional revisions of her own and saves them as private. Although B is notified of A's Revised #2 and A's Revised #3, B initially takes no action to merge or reject A's revisions. In action 760 “Revised #3 by B Published”, B publishes her Revised #3 whereby the system then notifies A of B's Revised #3; however, A takes no more actions. Instead, action 761 “A's Revision #3 Approved and Merged by B Private” occurs. In action 761, B reviews A's newest revisions, approves of them and merges them into B's Revised #3 version. Then in action 762 “Revised #4 by B Published”, B publishes the combined Revised #4 version. Although not shown in FIG. 7, A is notified of B's Revised #4 being published.

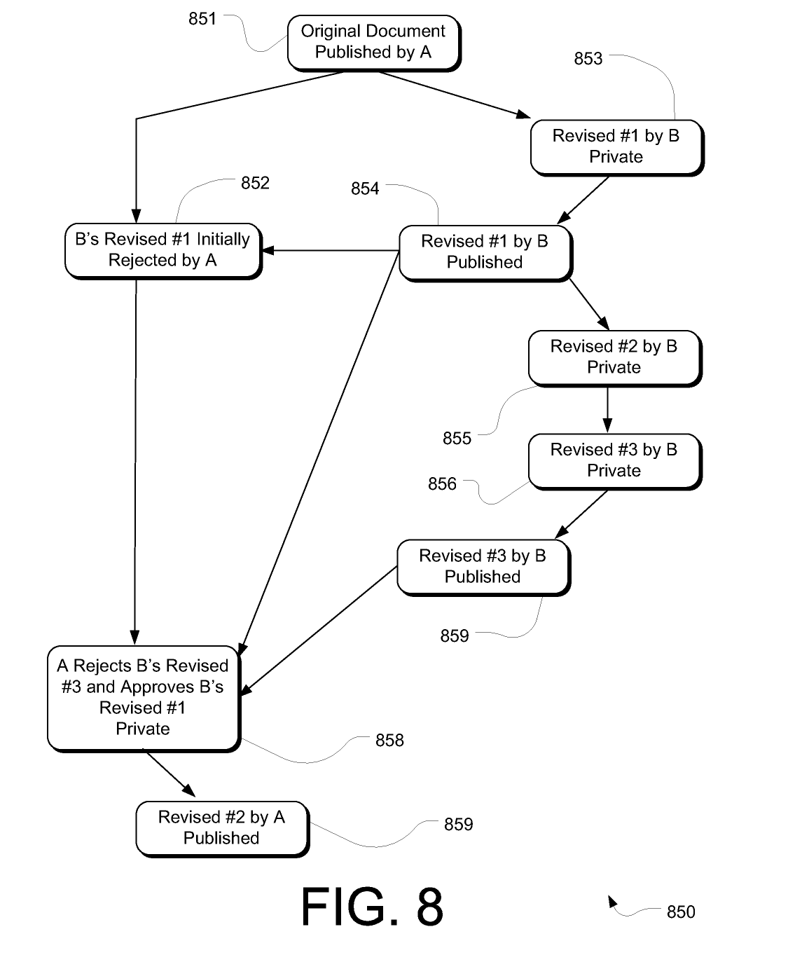

FIG. 8 illustrates an exemplary embodiment of user actions for employing a document revision system 850 showing that separate document branches can develop wherein different versions can be published and maintained separately without merging in the changes between them. In this illustration, user A publishes an original document in action 851 “Original Document Published by A”. User A shares this published document with user B, who then creates a copy and saves it as “Revised #1” in the “Revised #1 by B Private” action 853. As B saves Revised #1 as private, the system does not notify A of the revision or make Revised #1 available to others until after action 854 “Revised #1 by B Published”, wherein B publishes Revised #1. In action 852 “B's Revised #1 Initially Rejected by A”, A is notified of Revised #1 by B but initially rejects those changes.

User B then goes on to create Revised #2 in action 855 “Revised #2 by B Private” and saves it as private. B also creates Revised #3 in action 856 “Revised #3 by B Private” which he then publishes in action 859 “Revised #3 by B Published”. In action 858 “A Rejects B's Revised #3 and Approves B's Revision #1 Private”, A is notified of B's Revision #3 but rejects the new revisions and instead approves B's earlier revisions from Revised #1 by B and saves the new version as private. A then publishes his Revised #2 by A in action 859 “Revised #2 by A Published”.

In FIG. 8, the revisions are linked with bi-directional notifications (i.e., when B publishes a version, A is notified and when A publishes a version, B is notified). In another embodiment, user B could choose to create his Revised #1 and set notifications such that he is notified when changes are made to A's original document, but to not send notifications back to A when B makes changes to Revised #1. In this scenario, none of B's revisions would trigger notifications to A. This would be useful in several situations including when A and B are working on different but related documents. For example, A could be drafting contract boilerplate and B working with a specific contract. In this case, B would receive notification when the contract boilerplate is updated, but A would not receive notification when the contract specifics are changed. In yet another embodiment, A could refuse notifications from B regardless of whether B chose to send notifications to A or not.

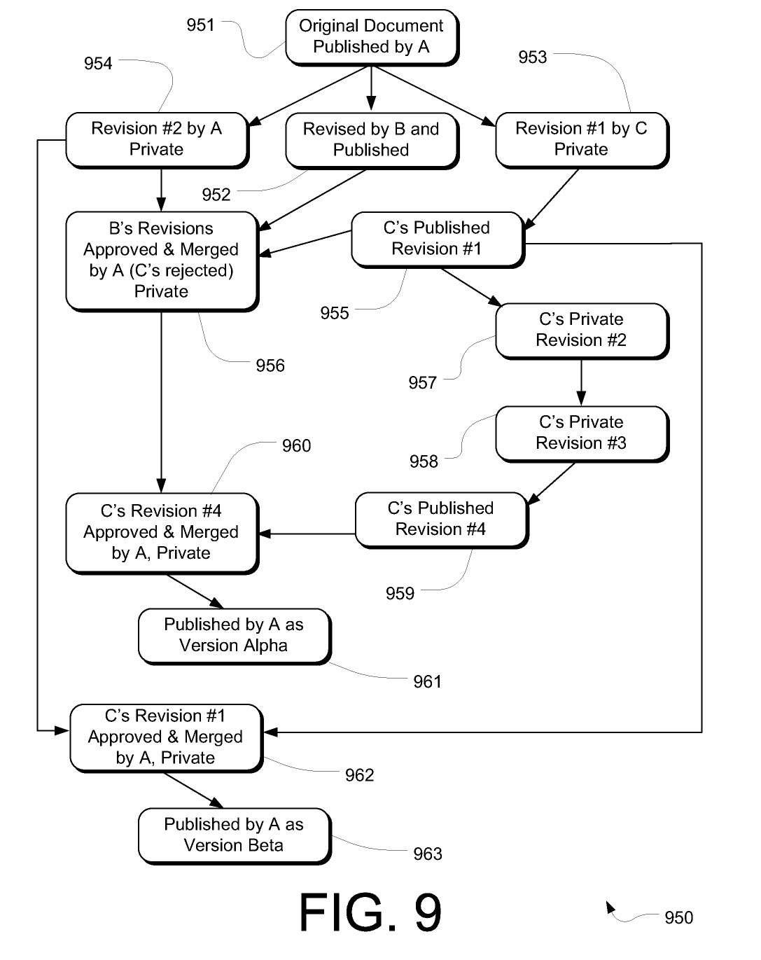

FIG. 9 illustrates an exemplary embodiment of user actions for employing a document revision system 950 showing that the system can support a plurality of users making revisions and merging and approving changes. In this illustration, user A publishes a version of an original document in action 951 “Original Document Published by A”. User A shares this published document with users B and C (in other embodiments, additional users are contemplated). User B makes revisions and publishes the new version in action 952 “Revised by B and Published”. User C also creates a revision but saves it as private in action 953 “Revision #1 by C Private”. Similarly, user A creates his own Revision #2 and saves it as private in action 954 “Revision #2 by A Private.” Bi-directional notifications are in place in this embodiment, so both A and C receive notice of B's published version, but neither is notified of the other's private version.

In action 955 “C's Published Revision #1”, user C saves his Revision #1 as published, triggering a notification to A. In action 956 “B's Revisions Approved & Merged by A (C's rejected) Private”, A approves and merges in B's revision but rejects C's revision, and then saves the resulting version as private. In actions 957 and 958, user C makes two more private revisions, Revision #2 and Revision #3. User C then publishes his revisions in step 959 “C's Published Revision #4”. A is notified thereof and approves and merges in C's Revision #4 to A's private revision in step 960 “C's Revision #4 Approved & Merged by A, Private”. Finally, in step 961, A publishes his formally private revisions as Document Alpha.

As highlighted in FIG. 9, the system allows a branching revision structure to be created so that users can create separate document branches that are related in their ancestries but are not intended to be merged back together into a single document. This can be clearly seen by the Document Alpha branch as illustrated in step 961 as well as the Document Beta branch that begins in step 962 “C's Revision #1 Approved & Merged by A, Private”, wherein A returns to his private Revision #2 and merges in C's Revision #1—note that this version does not include B's revisions. User A saves this combined Revision #1 by C and Revision #2 by A as private in step 962 but then goes on to publish it as Document Beta in step 963 “Published by A as Document Beta.”

In another embodiment, the revisions in FIG. 9 can be linked with bi-directional notifications (i.e., when either B or C publishes a revision, A is notified and when A publishes a revision, both B and C are notified). In this embodiment, if there were no notification links (i.e., notification links were non-existent) between B's view and C's view, then neither would be notified when the other published a new version. In yet another embodiment, user B could choose to create his Revised #1 and set notifications such that he is notified when changes are made to A's original document, but to not send notifications back to A when B makes changes to Revised #1. In this scenario, none of B's revisions would trigger notifications to A. This would be useful in several situations including when A and B are working on different but related documents. For example, A could be working on contract boilerplate and B could be editing a specific contract. In this case, B would receive notification when the contract boilerplate is updated, but A would not receive notification when the contract specifics are changed.

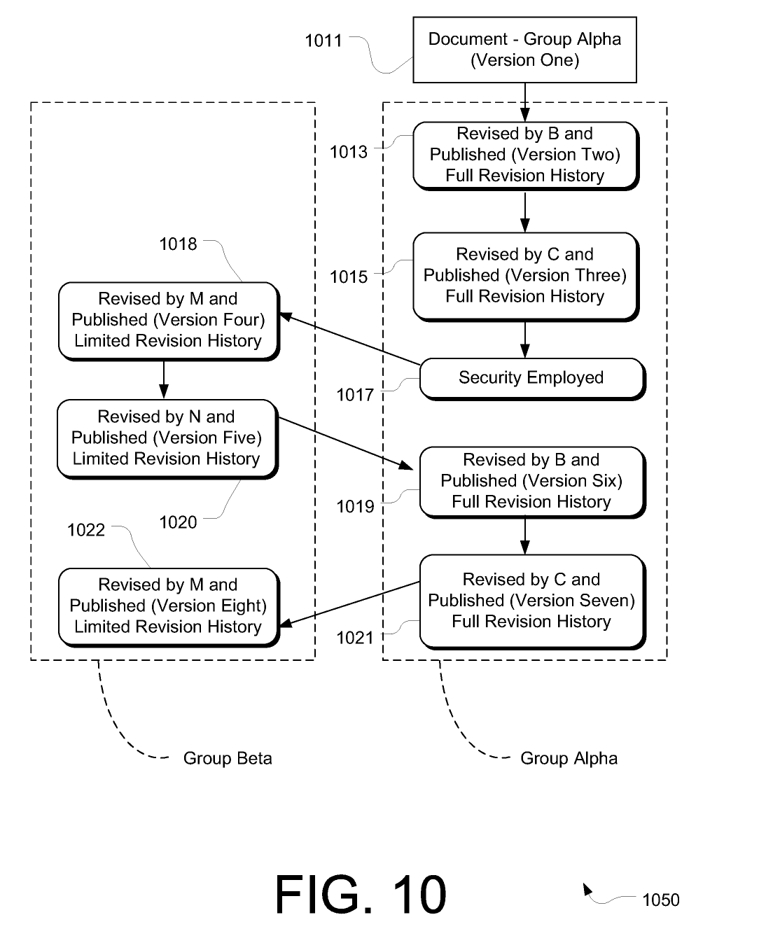

FIG. 10 illustrates an exemplary embodiment of user actions for employing a document revision system 1050 in an inter-organizational collaboration where revision history security is employed. Group Alpha contains members: user B and user C. A version of an original document, “Document—Group Alpha (Version One)” 1011, is introduced. User B revises Version One and publishes Version Two in the “Revised by B and Published (Version Two) Full Revision History” action 1013. Since B is a member of Group Alpha and there are no restrictions against him personally viewing the revision history of Version One, user B has full revision history access. User C revises Version Two and publishes Version Three in the “Revised by C and Published (Version Three) Full Revision History” action 1015. Since C is a member of Group Alpha and there are no restrictions against him personally viewing the revision history of Version One or Two, user C has full revision history access. However, C does not want anyone outside of Group Alpha to see the full revision history of Version Three. The system allows C to implement this desire in the Security Employed action 1017, wherein the system sets the security parameters on the revision history of Versions One through Three to Group Alpha members only.

Version Three is then sent to user M (the system shares Version Three with M as directed by user C). User M is not a member of Group Alpha, but is instead a member of Group Beta. Because user C set the security parameters on Versions One through Three to protect the revision history of the document and only allow members of Group Alpha to view that revision history, user M can not see any but the last revision, Version Three. Nor can user M view any of the metadata (author, timestamp, descriptions, etc.) on versions written on the protected document (Versions One, Two or Three). In another embodiment, the system could authorize M to view metadata on Version Three, Version Two, neither, or both. In yet another embodiment, since Version One was not created inside Group Alpha, user M could view that portion of Version Three's revision history that refers to Version One and any ancestors thereof, despite Version Two and the metadata for Versions Two and Three being hidden from him.

In the embodiment shown in FIG. 10, user M makes his own revisions and saves the version as published in “Revised by M and Published (Version Four) Limited Revision History” action 1018. User M chooses not to employ additional security on his Version Four. When user N revises it and creates Version Five in the “Revised by N and Published (Version Five) Limited Revision History” action 1020, she also chooses not to employ additional security. Thus, when user N sends the document revisions back to user B (via the system notifying B of changes), B can view the revision history and see the changes introduced by C in Version Three (since B is a member of Group Alpha), those introduced by M in Version Four (since M did not employ additional security), and those introduced by N in Version Five (since N did not employ additional security). The system identifies and tracks who made which changes. In “Revised by B and Published (Version Six) Full Revision History” action 1019, user B makes revisions and publishes the resulting version as Version Six.

In “Revised by C and Published (Version Seven) Full Revision History” action 1021, user C makes revisions and publishes the resulting version as Version Seven. User C can view the full revision history since he is also a member of Group Alpha. On the other hand, when C sends his published Version Seven (on which security settings are again applied) to user M, M can not see the revision history of the changes made by members within Group Alpha, since M is not a member of Group Alpha. Hence, in the “Revised by M and Published (Version Eight) Limited Revision History” action 1022, user M has limited access to the revision history of Version Seven. Nevertheless, M can still make his own revisions and publish Version Eight. In one embodiment, the access control settings for revisions in the revision history are inherited from the document on which the revision is created. Therefore, the scenario in FIG. 10 can occur without users manually assigning permissions to revisions given the presence of two documents with different security settings, and appropriate notifications between them. One is used by Group Alpha and is only accessible to Group Alpha. B and C make their changes on this document. Another is open, and therefore it and any revisions created on it are visible to all.

In another embodiment, user M and user N are members of Group Beta and decide to enact security on their versions, limiting revision history viewing to only those users in Group Beta. In this scenario, information concerning Version Four would be redacted from the revision history when viewed by either user B or user C. In yet another embodiment, instead of basing the security parameters on users' group memberships, other factors, including individual security settings per user, could be employed.

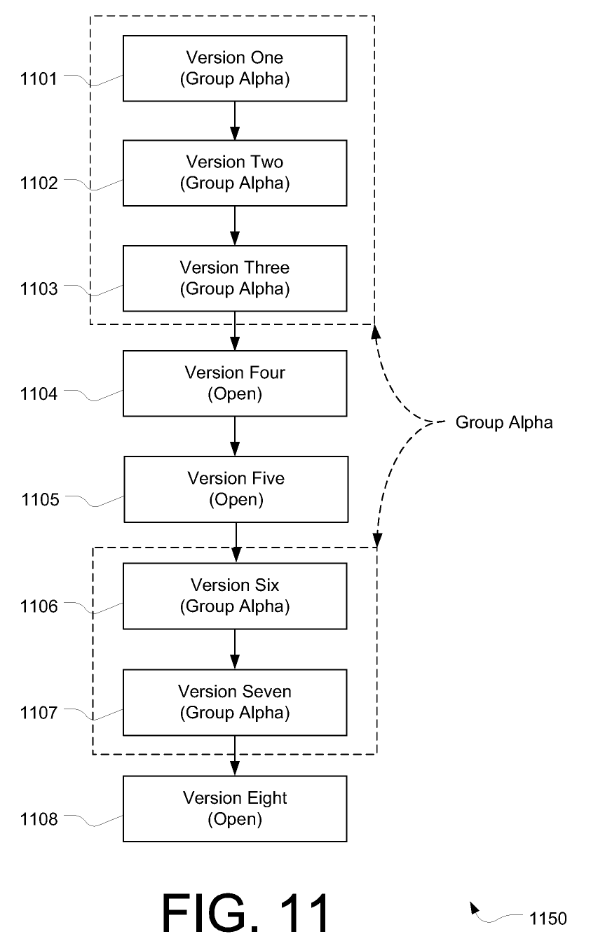

FIG. 11 illustrates an exemplary embodiment of a directed acyclic graph used to represent the state of the revision history 1150 after action 1022 in FIG. 10. The revision history 1150 consists of a directed acyclic graph in which the nodes of the graph are document versions 1101, 1102, 1103, 1104, 1105, 1106, 1107, and 1108 which represent versions of a formatted office document that various users have saved from time to time. In addition to the content of the document version, the nodes may contain metadata such as author, creation date, security information, etc. The edges, represented by arrows in FIG. 11, between the nodes represent the ancestry of a version. An edge points from a parent version to a later child version and indicates that the child version was created from the parent version. Since the versions in FIG. 11 are serial in nature, only one edge (or arrow) exists between each version.

The metadata on the versions in the revision history include the security parameters described above and are shown inside each version. Versions only visible to Group Alpha are labeled “Group Alpha” and versions visible to anyone are labeled “Open”. The dotted lines indicate sections of the revision history that will be redacted from users that are not members of Group Alpha. Those users will only be able to see the content of the final version before an open version (versions 3 and 7 respectively). Metadata of the redacted versions may also be hidden from these users.

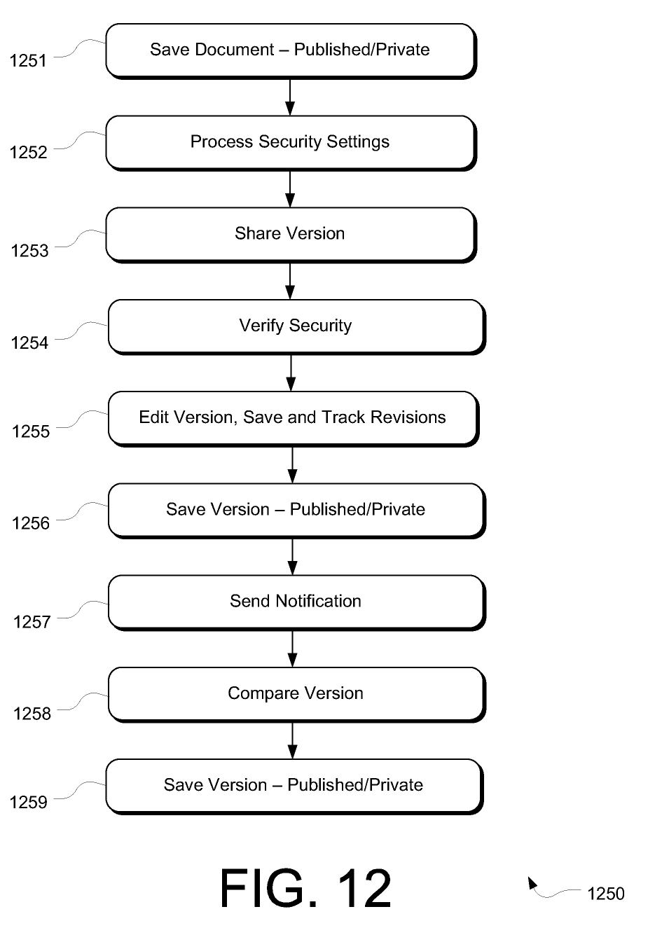

FIG. 12 illustrates an exemplary embodiment of detailed exemplary operations for a method of managing a document revision system 1250 employing revision history security. In the illustration in FIG. 12, a basic method is shown, other methods are contemplated in other embodiments. In the “Save Document—Published/Private” step 1251, the system presents users with the ability to save a particular set of revisions as a private version (i.e., no other users will be notified of the changes nor allowed to view them) or as a published version (i.e., other users can be notified of the changes and allowed to view them).

In step “Process Security Settings” 1252, the system presents a user with options to add security or access control to the version and/or its revision history. The user can then select an organization to move the version into. In another embodiment, the user can also select one or more groups within the organization that have permissions to access the document revisions. In yet another embodiment, the user can select custom permissions for the version. By performing this step, the system is locking the document so that only users with the appropriate permissions can access the document and/or its revision history. Alternatively, individual users can be authorized to access the document and/or its revision history.

The “Share Version” step 1253 occurs when the user activates the Share menu option. The system can present the user with a number of different sharing options (such as via email, as a website link, as an attachment, or via social networking tools) and then can assist the user in accomplishing the sharing.

In the Verify Security step 1254, the system compares a user's permissions, group memberships, etc. to the security settings on the version and/or revision history and authorizes the user as appropriate.

In the “Edit Version, Save and Track Revisions” step 1255, the system provides a plurality of users with the ability to edit the document (i.e., create revisions or new versions). The system saves and tracks the revisions as a revision history. Users are provided with the opportunity to save their revisions in the “Save Version—Published/Private” step 1256. Here the system presents the users with the ability to save a particular set of revisions as private (i.e., no other users will be notified of the changes nor allowed to view them) or as published (i.e., other users can be notified of the changes and allowed to view them). If a user chooses to save his or her version as published (i.e., publish the changes) then the system in step 1257 “Send Notification” will notify all those who have documents that are linked to the revision history of the document with the new published changes (unless notifications on the version are set to non-existent, in which case no notifications will be sent).

Any user who receives the notification can then choose to act upon it. In step 1258 “Compare Version”, the system presents a user with the option to compare the new published version with that user's current version (or with previous versions in the revision history). The user can choose to have the system perform the comparison, and will then be presented with the option of automatically merging the changes into his or her document if there aren't any conflicts or being presented with the differences and given an opportunity to accept or reject them. In the “Save Version—Published/Private” step 1259, the system allows the user to save his or her newly merged revisions as either a new private or published version.

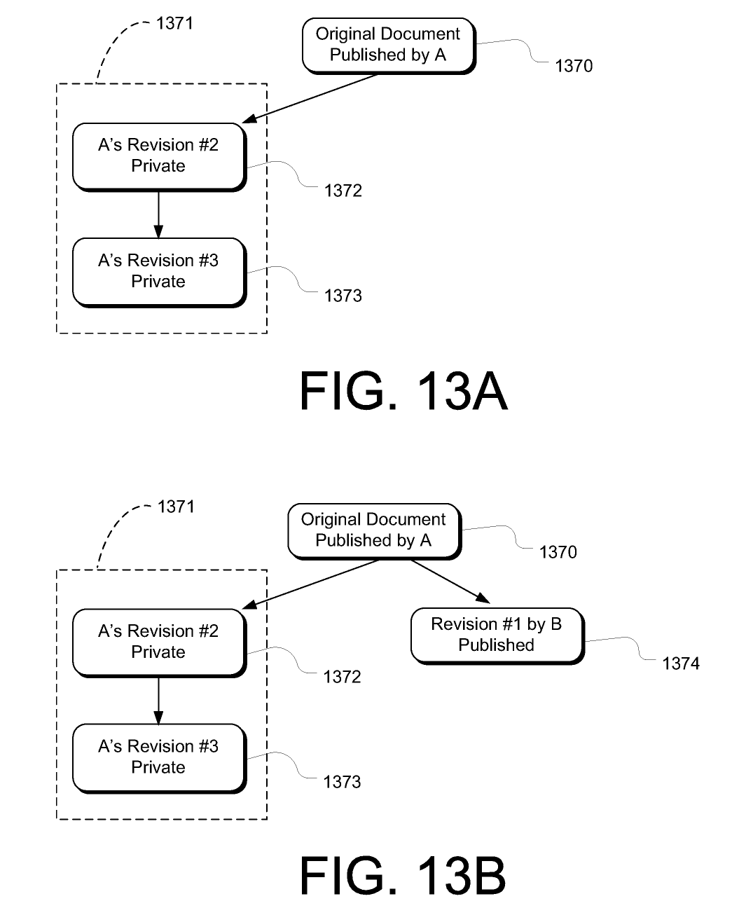

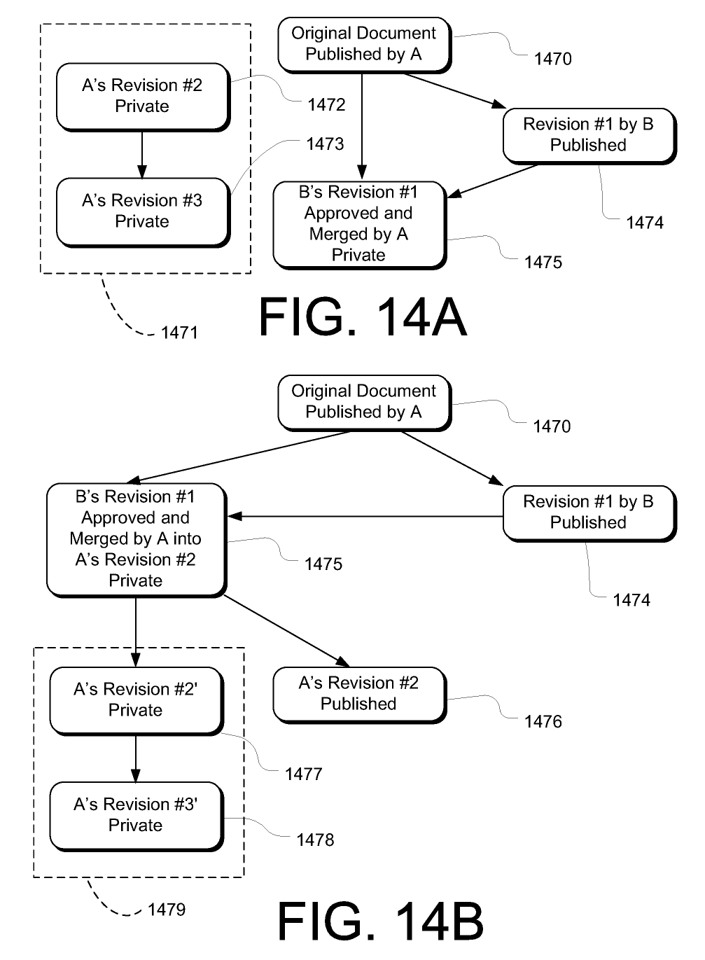

FIG. 13A illustrates an exemplary embodiment of user actions for employing a document revision system detailing a portion of the process of “sidelining”. In action 1370 “Original Document Published by A”, user A publishes a document. A then goes on to make two revisions, the first in “A's Revision #2 Private” action 1372 and the second in “A's Revision #3 Private” action 1373. A has saved these as private versions and so no other user can view them. This sets the stage for the need to perform a sideline, as further illustrated in FIGS. 13B, 14A and 14B. The broken-line box 1371 surrounding 1372 and 1373 highlights those versions which will be the subject of the sideline.

FIG. 13B illustrates an exemplary embodiment of user actions for employing a document revision system further detailing the process of sidelining. As noted above, in action 1370 “Original Document Published by A”, user A publishes a document. User B makes a Revision #1 in “Revision #1 by B Published” action 1374 and publishes his revision. Meanwhile, A goes on to make two revisions, the first in “A's Revision #2 Private” action 1372 and the second in “A's Revision #3 Private” action 1373. The broken-line box 1371 surrounding 1372 and 1373 highlights those versions which will be the subject of the sideline.

FIG. 14A illustrates an exemplary embodiment of user actions for employing a document revision system further detailing the process of sidelining. As in FIG. 13B, in “Original Document Published by A” 1470 A publishes the original version, in “A's Revision #2 Private” 1472 A publishes his first private version, in “A's Revision #3 Private” 1473 A publishes his second private version, and in “Revision #1 by B Published” 1474 B publishes his Revision #1. User A is notified of B's published Revision #1 and A decides he would like to merge in B's revisions. However, A wants to continue working on his private revisions. Therefore, A sidelines his private revisions, Revision #2 and Revision #3, represented in FIG. 14A as temporarily pulling the private revisions out of document flow and setting them aside in a sideline box 1471. A can then go forward with approving and merging in B's revisions into a new private version for A as shown in action “B's Revision #1 Approved and Merged by A Private” 1475.

FIG. 14B illustrates an exemplary embodiment of user actions for employing a document revision system further detailing the process of sidelining. As in FIG. 14A: in “Original Document Published by A” 1470, A publishes the original version; in “Revision #1 by B Published” 1474, B publishes his Revision #1; and in “B's Revision #1 Approved and Merged by A into A's Revision #2 Private” 1475, A approves and merges in B's Revision #1 into a new version called A's Revision #2 private. The previously sidelined A's Revision #2 private and A's Revision #3 private are not shown in FIG. 14B. Instead, in this embodiment, A has published his formerly private revision (item 1475) in action “A's Revision #2, Published” 1476. And A has also unsidelined his previously sidelined revisions, bringing them back into the document flow as “A's Revision #2′ Private” 1477 and “A's Revision #3′ Private” 1478, collectively unsidelined versions 1479. The new Revision #2′ and Revision #3′ include the revisions made by B in Revision #1 as well as those changes made by A in the original A's Revision #2 and A's Revision #3, respectively. These new versions are created automatically by the system using a three-way merge. The system may optionally pause the merging in of version #3 if the merge of Revision #2 causes a conflict. After the user resolves any conflict, they can resume the unsideline process to merge the remaining sideline (Revision #3) to the document. At this stage, A can continue to work on his private Revisions #2′ and #3′, having successfully integrated in to those versions the revisions made by B in Revision #1 by B. Furthermore, other users will have the updated published A's Revision #2 to work from and do not have to wait for A to publish #2′ or #3′ in order to see the changes made by B in Revision #1. Because A's original revisions (#2 and #3) were private, we can be sure that they are in no other version's revision history and therefore can be safely discarded after the sideline is deleted.

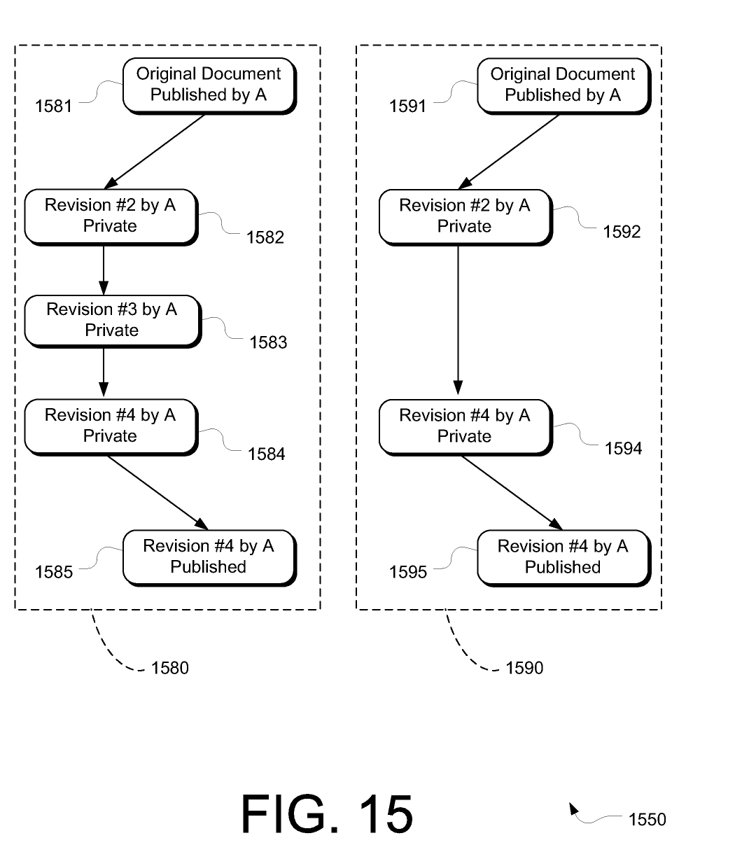

FIG. 15 illustrates an exemplary embodiment of user actions for employing a document revision system detailing the process of pruning 1550. Broken line box 1580 contains the revision history representation before pruning and broken line box 1590 shows the revision history representation after pruning. “Original Document Published by A” 1581 is the working version of the original document published by A. A then makes a private revision, “Revision #2 by A Private” 1582. Additional revisions are necessary and so A makes a second private revision, “Revision #3 by A Private” 1583. A final private revision is necessary and so A makes “Revision #4 by A Private 1584. When A subsequently makes “Revision #4 by A Published” 1585, the resulting revision history contains a complex series of three private revisions detailing all the revisions that A made in the intervening versions. If A would rather not store a detailed record of the intervening versions, A can prune Revision #3. After doing so, the revision history representation will be as shown in broken line box 1590: “Original Document Published by A” 1591, “Revision #2 by A Private” 1592, “Revision #4 by A Private” 1594, and “Revision #4 by A Published” 1595. The revision history will no longer contain a separate node detailing the revisions formerly contained in Revision #3. Because Revision #3 was private, it does not appear in the revision history of any other document, and therefore it can be safely deleted without introducing errors in other document's revision histories.

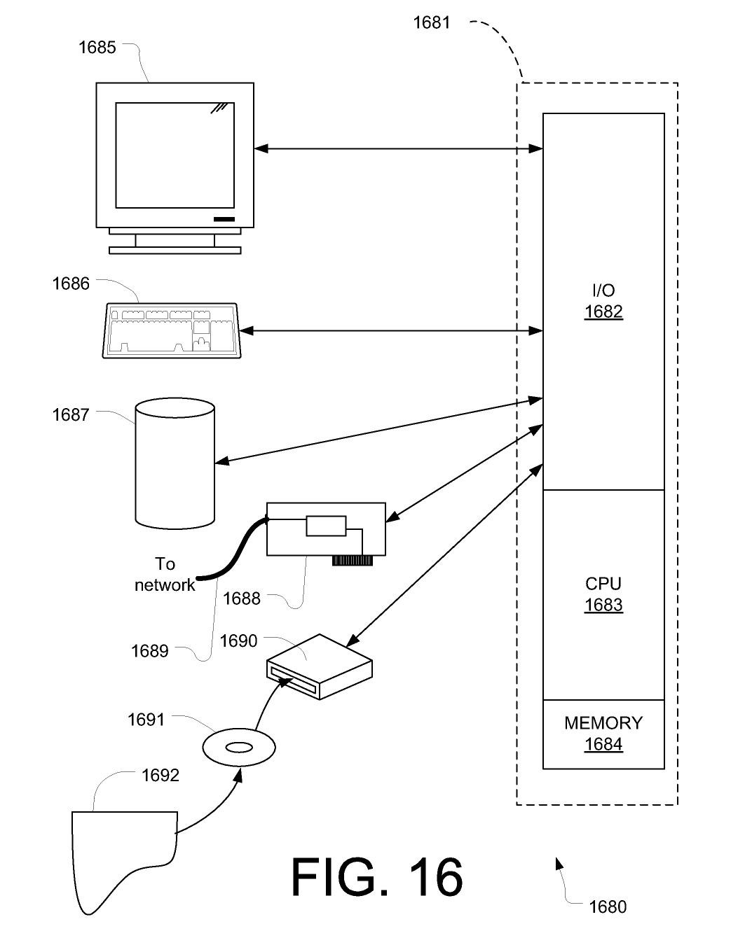

FIG. 16 illustrates an exemplary embodiment of a computing system 1680 useful in implementations of the described technology. A general purpose computer system 1680 is capable of executing a computer program product to execute a computer process. Data and program files may be input to the computer system 1680, which reads the files and executes the programs therein. Some of the elements of a general purpose computer system 1680 are shown in FIG. 16 wherein a processor 1681 is shown having an input/output (I/O) section 1682, a Central Processing Unit (CPU) 1683, and a memory section 1684. There may be one or more processors 1681, such that the processor 1681 of the computer system 1680 comprises a single central-processing unit 1683, or a plurality of processing units, commonly referred to as a parallel processing environment. The computer system 1680 may be a conventional computer, a distributed computer, or any other type of computer. The described technology is optionally implemented in software devices loaded in memory 1684, stored on a configured DVD/CD-ROM/OPTICAL DISC 1691 or storage unit 1687, and/or communicated via a wired or wireless network link 1689 on a carrier signal, thereby transforming the computer system 1680 in FIG. 16 into a special purpose machine for implementing the described operations. The computing system 1680 provides a means for enabling the processor(s) 1681 to access a plurality of modules in memory 1684/storage 1687 for the document revision management application. The computing system 1680 further provides a second means for enabling the processor(s) 1681 to implement the plurality of modules.

The I/O section 1682 is connected to one or more user-interface devices (e.g., a keyboard 1686 and a display unit 1685), a disk storage unit 1687, and a disk drive unit 1690. Generally, in contemporary systems, the disk drive unit 1690 is a DVD/CD-ROM/OPTICAL drive unit capable of reading the DVD/CD-ROM/OPTICAL DISC medium 1691, which typically contains programs and data 1692. Said drive unit 1690 may alternatively be a USB thumb drive, memory stick, or any other memory/storage medium. Computer program products containing mechanisms to effectuate the systems and methods in accordance with the described technology may reside in the memory section 1684, on a disk storage unit 1687, or on the DVD/CD-ROM/OPTICAL medium 1691 of such a system 1680. Alternatively, a disk drive unit 1690 may be replaced or supplemented by a floppy drive unit, a tape drive unit, or other storage medium unit. The network adapter 1688 is capable of connecting the computer system to a network via the network link 1689, through which the computer system can receive instructions and data embodied in a carrier wave. Examples of such systems include SPARC systems developed by Sun Microsystems, Inc., personal computers offered by Dell Corporation and by other manufacturers of personal computers, Apple-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1680 is connected (by wired connection or wirelessly) to a local network through the network interface or adapter 1688, which is one type of communications device. When used in a WAN-networking environment, the computer system 1680 typically includes a modem, a network adapter, or any other type of communications device for establishing communications over the wide area network. In a networked environment, program modules depicted relative to the computer system 1680 or portions thereof, may be stored in a remote memory storage device. It is appreciated that the network connections shown are exemplary and other means of, and devices for, establishing a communications link between the computers may be used.

In accordance with an implementation, software instructions and data directed toward implementing a document revision manager and other operations may reside on disk storage unit 1687, disk drive unit 1690 or other storage medium units having computer readable logic embodied in said storage medium and coupled to the system (directly and/or through a network interface 1688). Said software instructions may also be executed by processor CPU 1683. The embodiments of the disclosure described herein can be implemented as logical steps in one or more computer systems. The logical operations of the present disclosure are implemented (1) as a sequence of processor-implemented steps executing in one or more computer systems and/or (2) as interconnected machine or circuit modules within one or more computer systems. The implementation is a matter of choice, dependent on the performance requirements of the computer system implementing the embodiment. Accordingly, the logical operations making up the embodiments described herein may be referred to variously as processes, operations, steps, objects, or modules. Furthermore, it should be understood that logical operations may be performed in any order, unless explicitly claimed otherwise or a specific order is inherently necessitated by the claim language.

While particular embodiments have been described and disclosed in the present application, it is clear that any number of permutations, modifications, or embodiments may be made without departing from the spirit and the scope of this disclosure.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize. Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers, are incorporated herein by reference. Aspects of embodiments can be modified, if necessary, to employ the systems, functions, and concepts of the various references to provide yet further embodiments.

In light of the above “Detailed Description,” the Inventor may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the inventor. As discussed herein, specific terminology used when describing certain features or aspects should not be taken to imply that the terminology is being redefined herein to be restricted to any specific characteristics, features, or aspects of the embodiments with which that terminology is associated.

While certain aspects are presented below in certain claim forms, the inventor contemplates the various aspects in any number of claim forms. Accordingly, the inventor reserves the right to add additional claims after filing the application to pursue such additional claim forms for other aspects.

The above specification, examples and data provide a description of the structure and use of exemplary implementations of the described systems, articles of manufacture and methods. It is important to note that many implementations can be made without departing from the spirit and scope of the disclosure.

What is claimed is:

1. A method in a document revision management system in a computing device, comprising:
operating software modules in the computing device in order to allow a plurality of users to revise a formatted office document provided by a first user, the system utilizing lockless collaboration such that the plurality of users can edit a plurality of versions of the formatted office document concurrently, the software modules interacting to form the document revision management system;
providing a second user a means for revising an original version of the formatted office document to create a first version of the plurality of versions, wherein the first version differs from the original version by a first set of revisions;
initiating a branching revision history by processing a directed acyclic revision history graph that stores information concerning ancestry of the plurality of versions of the formatted office document, wherein the revision history includes information about the first user, the second user, the original version, the first version, interrelations between the original version and the first version, and information regarding the first set of revisions;
tracking the first set of revisions in the branching revision history based on user actions concerning the first set of revisions; and
comparing and merging revisions, wherein the system merges at least one revision of the first set of revisions into a third version of the formatted office document.

2. The method of claim 1, further comprising:
providing the second user a means for saving the first version as private so other users cannot view the first set of revisions.

3. The method of claim 1, further comprising:
providing the second user a means for saving the first version as published so other users can view the first set of revisions.

4. The method of claim 1, further comprising:
providing the first user a means for selecting whether notifications are one of unidirectional, bidirectional, and non-existent, wherein the system distributes a selected notification upon publication of the first version.

5. The method of claim 1, further comprising:
splitting off a related formatted office document that shares the branching revision history of the formatted office document, wherein the formatted office document and the related formatted office document each have a corresponding current version in the branching revision history.

6. The method of claim 1, further comprising:
providing the first user a means for revising the original version of the formatted office document to create a sideline version of the plurality of versions, wherein the sideline version differs from the original version by a sideline set of revisions;
wherein the comparing and merging revisions that results in the third version further includes maintaining the sideline version apart from the comparing and merging that results in the third version; and
providing the first user a means for comparing and merging the sideline version and the third version, wherein the system provides the first user a means for reviewing the sideline set of revisions and selectively merging at least one revision of the sideline set of revisions into a fourth version of the formatted office document.

7. The method of claim 1, further comprising:
providing the first user with a means to choose whether the comparing and merging revisions is moderated such that the first user determines which of the first set of revisions is merged into the third version of the formatted office document.

8. The method of claim 7, further comprising:
when the first user chooses the comparing and merging revisions to be moderated, providing notification to the first user when the second user makes the first version available to the first user.

9. The method of claim 7, further comprising:
when the first user chooses the comparing and merging revisions to be moderated, providing notification to the second user when a merger occurs that results in the third version.

10. The method of claim 1, further comprising:
providing the first user with a means to choose whether the comparing and merging revisions is unmoderated such that the system automatically merges at least some of the first set of revisions into the third version of the formatted office document.

11. The method of claim 1, further comprising:
displaying the branching revision history in response to a request to do so by a requesting user, wherein the requesting user can see differences between selected versions of the formatted office document in the branching revision history as well as corresponding metadata.

12. The method of claim 1, further comprising:
providing the first user a means for specifying security parameters for the plurality of versions of the formatted office document that determine which users can access which versions of the formatted office document.

13. The method of claim 12, wherein providing the first user a means for specifying security parameters further includes:
displaying the branching revision history such that details concerning a specific version in the branching revision history are hidden from unauthorized users.

14. A document revision management tool in a computing device, comprising:
a lockless collaboration module configured such that a plurality of users can edit a plurality of versions of a formatted office document concurrently, the formatted office document associated with a first user;
a document revision module configured to provide a second user the ability to revise an original version of the formatted office document to create a first version of the plurality of versions, wherein the first version differs from the original version by a first set of revisions;
a branching revision history module that processes a directed acyclic revision history graph that stores information concerning ancestry of versions of documents, and wherein the revision history module uses the graph to store information about the first user, the second user, the original version, the first version, interrelations between the original version and the first version, and how the first user and second user interact with the original version and the first version;
a branching revision history maintenance module that tracks the first set of revisions made by the second user in the revision history graph;
a publication notification distribution module that provides the first user a means for selecting whether notifications are one of unidirectional, bidirectional, and non-existent, and wherein the tool distributes a selected notification upon a new published version becoming available; and
a comparing and merging revisions module that provides the first user a means for reviewing the first set of revisions and a means for merging at least one of the revisions into a third version of the formatted office document.

15. The document revision management tool of claim 14, further comprising:
a private and public revisions management module that provides the second user a means for saving the first version as private so no other users can view the first set of revisions.

16. The document revision management tool of claim 14, further comprising:
a private and public revisions management module that provides the second user a means for saving the first version as published so other users can view the first set of revisions.

17. The document revision management tool of claim 14, further comprising:
a sidelining module that provides the first user a means for revising the original version of the formatted office document to create a sideline version of the plurality of versions, wherein the sideline version differs from the original version by a sideline set of revisions;
wherein the sidelining module maintains the sideline version apart from the comparing and merging revisions module that results in the third version; and
the sidelining module provides the first user a means for comparing and merging the sideline version and the third version, wherein the system provides the first user a means for reviewing the sideline set of revisions and selectively merging at least one revision of the sideline set of revisions into a fourth version of the formatted office document.

18. The document revision management tool of claim 14, further comprising:
a moderated and unmoderated collaboration module that provides the first user with a means to choose whether the comparing and merging module employs moderated collaboration such that the first user determines which of the first set of revisions is merged into the third version of the formatted office document.

19. The document revision management tool of claim 14, further comprising:
a moderated and unmoderated collaboration module that provides the first user with a means to choose whether the comparing and merging module employs unmoderated collaboration wherein the tool automatically merges at least some of the first set of revisions into the third version of the formatted office document.

20. The document revision management tool of claim 14, further comprising:
a specifying security parameters module that provides the first user with a means for specifying security parameters for the formatted office document that determine which users can access which versions of the formatted office document.

21. The document revision management tool of claim 14, further comprising:
a revision history display module that displays the branching revision history in response to a request to do so by a requesting user; wherein the requesting user can see differences between selected versions of the formatted office document in the branching revision history as well as corresponding metadata.

22. The document revision management tool of claim 21, further comprising:
a specifying security parameters module that provides the first user with a means for specifying security parameters for the plurality of versions of the formatted office document that determine which users are authorized to access which versions of the formatted office document.

23. The document revision management tool of claim 22, further comprising:
the revision history display module displaying the branching revision history such that details concerning a specific version in the branching revision history are hidden from unauthorized users.

24. A computer program product comprising a computer usable storage medium having computer readable logic embodied in said storage medium for enabling a processor to implement a document revision management application, comprising:
first means for enabling the processor to access a plurality of modules in storage for the document revision management application;
second means for enabling the processor to implement the plurality of modules, the modules including at least:
a lockless collaboration module configured such that a plurality of users can edit a plurality of versions of a formatted office document concurrently, the formatted office document associated with a first user;
a document revision module configured to provide a second user the ability to revise an original version of the formatted office document to create a first version of the plurality of versions, wherein the first version differs from the original version by a first set of revisions;
a branching revision history module that processes a directed acyclic revision history graph that stores information concerning ancestry of versions of documents, and wherein the revision history module uses the graph to store information about the first user, the second user, the original version, the first version, interrelations between the original version and the first version, and how the first user and second user interact with the original version and the first version;
a branching revision history maintenance module that tracks the first set of revisions made by the second user in the revision history graph;
a publication notification distribution module that provides the first user a means for selecting whether notifications between the original version and the first version are one of unidirectional, bidirectional, and non-existent, and wherein the tool distributes a selected notification upon a new published version becoming available; and
a comparing and merging revisions module that provides the first user a means for reviewing the first set of revisions and a means for merging at least one of the revisions into a third version of the formatted office document

25. The computer program product of claim 24, further comprising:
a private and public revisions management module that provides the second user a means for saving the first version as private so no other users can view the first set of revisions.

26. The computer program product of claim 24, further comprising:
a private and public revisions management module that provides the second user a means for saving the first version as published so other users can view the first set of revisions.

27. The computer program product of claim 24 further comprising:
a sidelining module that provides the first user a means for revising the original version of the formatted office document to create a sideline version of the plurality of versions, wherein the sideline version differs from the original version by a sideline set of revisions;
wherein the sidelining module maintains the sideline version apart from the comparing and merging revisions module that results in the third version; and
the sidelining module provides the first user a means for comparing and merging the sideline version and the third version, wherein the system provides the first user a means for reviewing the sideline set of revisions and selectively merging at least one revision of the sideline set of revisions into a fourth version of the formatted office document.

28. The computer program product of claim 24, further comprising:
a moderated and unmoderated collaboration module that provides the first user with a means to choose whether the comparing and merging module employs moderated collaboration such that the first user determines which of the first set of revisions is merged into the third version of the formatted office document.

29. The computer program product of claim 24, further comprising:
a moderated and unmoderated collaboration module that provides the first user with a means to choose whether the comparing and merging module employs unmoderated collaboration wherein the tool automatically merges at least some of the first set of revisions into the third version of the formatted office document.

30. The computer program product of claim 24, further comprising:
a specifying security parameters module that provides the first user with a means for specifying security parameters for the formatted office document that determine which users can access which versions of the formatted office document.

31. The document revision management tool of claim 24, further comprising:
a revision history display module that displays the branching revision history in response to a request to do so by a requesting user; wherein the requesting user can see differences between selected versions of the formatted office document in the branching revision history as well as corresponding metadata.

32. The document revision management tool of claim 31, further comprising:
a specifying security parameters module that provides the first user with a means for specifying security parameters for the plurality of versions of the formatted office document that determine which users are authorized to access which versions of the formatted office document.

33. The document revision management tool of claim 32, further comprising:
the revision history display module displaying the branching revision history such that details concerning a specific version in the branching revision history are hidden from unauthorized users.
